(19) United States
(12) Patent Application Publication
(10) Pub. No.: US 2022/0076335 A1
(43) Pub. Date: Mar. 10, 2022

(54) SYSTEM AND METHOD FOR DIGITIZATION FINANCIALIZATION AND DIGITAL VALUATION OF PRECIOUS METAL ASSETS

(71) Applicant: RAJESH SUKUMARAN, Ernakulam (IN)

(72) Inventor: RAJESH SUKUMARAN, Ernakulam (IN)

(21) Appl. No.: 17/467,643

(22) Filed: Sep. 7, 2021

(30) Foreign Application Priority Data
Sep. 8, 2020 (IN) 202041038738

(51) Int. Cl. G06Q 40/04; G06Q 20/38; G06Q 20/40

(52) U.S. Cl. CPC G06Q 40/04; G06Q 20/401; G06Q 20/389

(57) ABSTRACT

Exemplary embodiments of the present disclosure are directed towards A system for digitization financialization and digital valuation of precious metal assets comprising of: a first subsystem 104 and a second subsystem 106, also referred to as subsystem 1 104 and subsystem 2 106 respectively, and the first subsystem 104 comprises of an asset data digitizer 104a to create an immutable digital record 104b of the precious metal asset of the user 102 preferably as a 3D scan and the output of the first subsystem 104 is an input of the second subsystem 106, and the second subsystem 106 makes the asset records available to plurality of financial service providers based on the requirements of the user 102 through a user interface 106a, which belongs to the user and financial service provider interface belongs to the financial service providers, and the user interface 106a enables the user 102 to choose the services 106c that suit the user's 102 requirements by comparing the competitive offers and close the deal and the system 100 uses the standard know your customer (KYC) process to identify the user 102 who is the owner of the precious metal asset.

### CROSS-REFERENCE TO RELATED APPLICATIONS

This application claims priority benefit of Indian non-provisional patent application No: 202041038738, filed on Sep. 8, 2020, entitled “System and Method for Digitization Financialization and Digital Valuation of Precious Metal Assets”. The entire contents of said patent application is hereby incorporated by reference herein.

### TECHNICAL FIELD

The present disclosure generally relates to the field of qualitative evaluation of precious metals. More particularly, the present disclosure relates to a system and method for valuation and digitization of precious metals and their products like jewelry or coins to enable financialization of precious metal assets.

### BACKGROUND

Gold and other precious metals have been used as a store of value for many centuries. The fungible nature and chemical inertness have enabled it to be used as currency in the past. Precious metals, especially gold, is one instrument of investment that is used by both sophisticated investors like pension funds, hedge funds, etc and the common person alike. Central Banks hold gold as part of their foreign exchange reserves due to high liquidity and long-term returns provided by gold. Gold is a safe haven investment that rises in value during economic crises. The attractive yellow hue of gold makes it ideal for jewellery that also acts as a savings for a rainy day.

The disadvantages of gold and other precious metals as an investment vehicle is that it does not have a yield. It is hard and expensive to store. Majority of gold holdings in the world are in the form of gold jewellery and they are mostly lying in the private safes or bank lockers. Lack of financialization of these assets means that these investments are idle capital that are not getting utilised in any commercial transactions. There is a need for an invention that addresses the lack of financialization of gold and precious metal jewellery and bullion that are currently lying as idle capital across the world. The invention would give the asset holders the ability to create digital assist derived from the gold assets in a secure and trusted manner which then give them the flexibility to use these assets in various financial transactions.

Current process of financialisation such as gold loan providers provides only one functionality, i.e availability funds using gold as security. It does not require digitisation per se. Majority gold ornaments are stored in the combank vaults and when in need of funds, the owner of the asset will have to take it from the vault and present it to the gold loan provider to avail the loan. Later on the person can use the digital asset representing gold assets to take a gold loan from any gold loan service provider on the platform without visiting the branch of the gold loan service provider.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for digitization financialization and digital valuation of precious metal assets.

An exemplary object of the present disclosure is directed towards creating a digital assist derived from the gold assets in a secure and trusted manner.

Another exemplary object of the present disclosure is directed towards flexibility for the user to use these assets in various financial transactions.

Yet another exemplary object of the present disclosure is directed towards creating new revenue streams for idle gold for such entities.

An exemplary aspect of the present subject matter is directed towards a computerized system for digitization, financialization and valuation of precious metal asset with a first subsystem 104 and a second subsystem 106, also referred to as subsystem 1 104 and subsystem 2 106 respectively, and the first subsystem 104 comprises of an asset data digitizer 104a to create an immutable digital record 104b of the precious metal asset of the user 102 preferably as a 3D scan and the output of the first subsystem 104 is an input of the second subsystem 106, and the second subsystem 106 makes the asset records available to plurality of financial service providers based on the requirements of the user 102 through a user interface 106a, which belongs to the user and financial service provider interface belongs to the financial service providers, and the user interface 106a enables the user 102 to choose the services 106c that suit the user's 102 requirements by comparing the competitive offers and close the deal and the system 100 uses the standard know your customer (KYC) process to identify the user 102 who is the owner of the precious metal asset.

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a block diagram depicting a system for digitization finacialization and digital valuation of precious metal assets, according to an exemplary embodiment of the present disclosure.

FIG. 2 is a step by step representation of a gold digitization system occurring in sub-system 1, according to an exemplary embodiment of the present disclosure.

FIG. 3 is a step by step representation of a service delivery process occurring in sub-system 2, according to an exemplary embodiment of the present disclosure.

FIG. 4 is a prior art depicting a Structure and Working a Gold exchange-traded fund (ETF), according to an exemplary embodiment of the present disclosure.

FIG. 4A is a block diagram depicting Structure Gold exchange-traded fund (ETF) unit creation process, according to an exemplary embodiment of the present disclosure.

FIG. 4B is a block diagram depicting exchange-traded fund (ETF) working model, according to an exemplary embodiment of the present disclosure.

FIG. 4C is a block diagram depicting a Modified Unit Creation Process, according to an exemplary embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

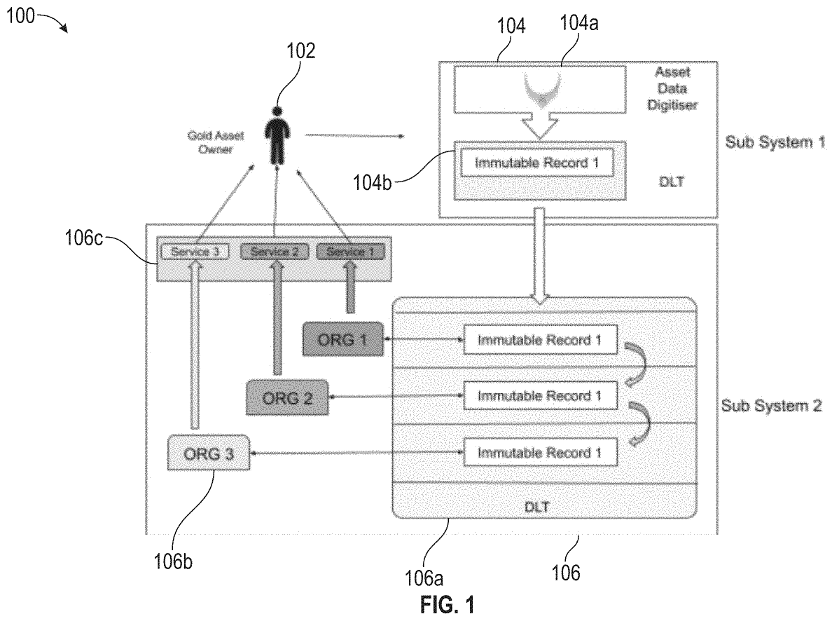

Referring to FIG. 1 is a block diagram 100, depicting a system for digitization financialization and digital valuation of precious metal assets, according to an exemplary embodiment of the present disclosure. A precious metal owner (gold asset owner) 102 is the user in this invention. The invention consists of a computerised system 100, consisting of a subsystem 1 104 which digitizes the gold assets by capturing the details of the physical form of the asset, its weight, purity and ownership. The digital immutable record, which is the output of the first subsystem, acts as an irrefutable record of ownership and value of the assets. The first subsystem 104 utilises fully automated or semi-automated devices to create an immutable digital record of the gold jewellery asset through an asset data digitiser 104a. The immutable record 1 104b created by the first subsystem captures the various properties of the jewellery such as type of the jewellery, dimension, weight and purity of the assets. It captures the video and photo of the assets as part of the immutable record 1 104b. The immutable record 1 104b also contains the details of the ownership of the asset.

The output of the first subsystem is used by a sub-system 2 106 to make the digital records available to financial organisations like bank, non-banking financial companies, credit card companies, insurance service providers, securitisation companies and the like based on the requirements of the owner of the gold and precious metal assets.

The sub-system 2 106 will provide the owner of the jewelry with the user interface 106a to specify the services the user is looking for. The sub-system 2 will then make the digital records that represent the gold asset in front of the financial companies (org1, org 2, org 3 106b) so that they can make the offer to provide their services to the owner of the asset. The owner of the asset will then be able to choose the services 106c that suit the user's requirements by comparing the competitive offers and close the deal. The system uses the standard know your customer (KYC) process to identify the owner of the asset.

The user interface (UI) will be of the asset owners (user 102) and service providers (financial service providers). The UI for the asset owners may be inclusive of: digitized asset details, current value of their assets, option to raise a fresh service request, not limiting to, a new gold loan, secure credit cards, bitcoins or any distributed ledger asset, and securitization of assets; an option to view service proposal from service providers; Lock or Unlock jewelry items, where the Locked jewellery items will not be available for a transaction. This feature enables asset owners to manage which jewellery they want to make available for certain transactions and an option to withdraw the unlocked jewellery.

The service provider interface involves a Web based dashboard which will be provided to service providers to view the overall transaction details and new service requests. The functionality of the provider are, not limited to, viewing a service request from asset owner, not limiting to, viewing an asset summary and requirement details, submitting the proposals and further approving the proposals, viewing the proposal status, viewing the transactions details for confirmed proposal (view asset details and transaction value and status), raise notifications for customer and close or terminate service.

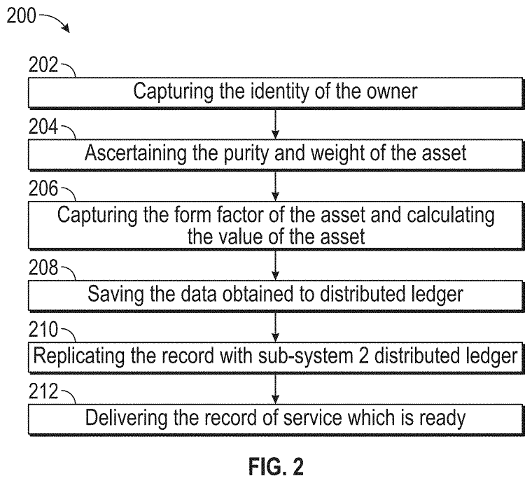

Referring to FIG. 2 is a step by step representation 200, of a gold digitization system occurring in sub-system 1, according to an exemplary embodiment of the present disclosure. UI elements of sub-system 1 are to capture asset owner details, the details of the asset and controls for the operation of the digitizing system. Firstly, a transaction button (enables the asset owner to place the asset in the jewelry tray provided in sub-system 1) is started. The authentication of the user is done, not limiting to an onboard user and/or an existing user (who needs to get started with a two-step authentication process). The authenticated user's details are used to capture at step 202, the new user's details, not limited to, photograph captured at the time of transaction, demographic details such as name of the user, geographic location, and the like; phone number, email address and other know your customer (KYC) details, without limiting the scope of the disclosure. Ascertaining the purity and weight of the asset is done at step 204. Further, capturing the form factor of the asset and calculating the value of the asset is done at step 206. The asset details may not be limited to; Number of asset items included in the transaction. For each asset following details are captured separately: a. High fidelity video; Weight and Purity of the asset.

The System one captures the weight of the assets as part of the digitisation process.

The value of the asset is based on the amount of gold by weight in the asset. The amount of gold by weight in the system is calculated based on the purity of the asset. For example, a gold asset with weight of 10 g and 22 kt purity will have 9.1666 gms of gold.

Value=Wt in grams×Putiy ratio×bullion price per gram.

The data obtained is saved to distributed ledger at step 208. Replicating the record with sub-system 2's distributed ledger is done at step 210. Delivering the record of service which is ready is done at step 212. The revenue will be a basis point of the value of transactions happening on the system.

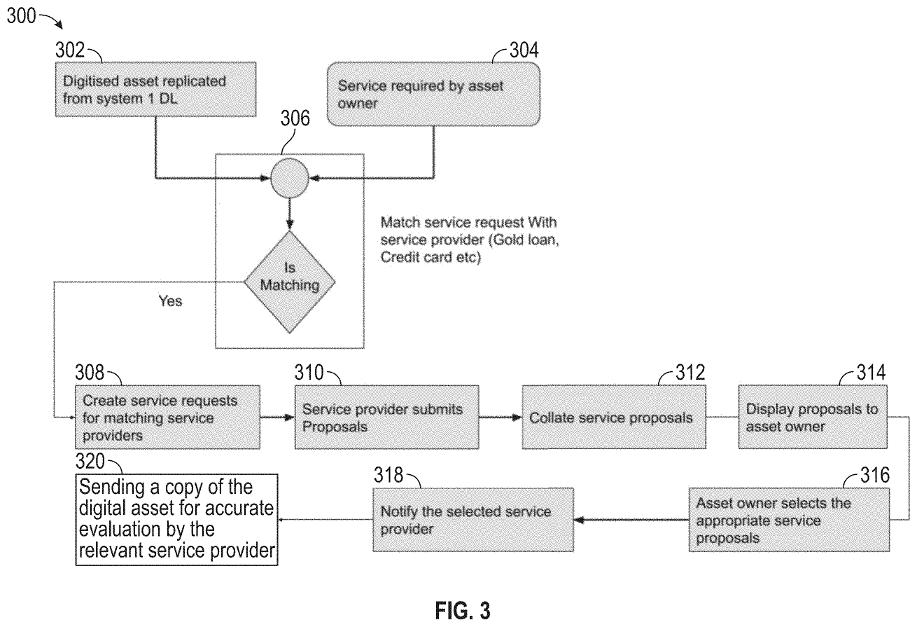

Referring to FIG. 3 is a step by step representation 300, of a service delivery process occurring in sub-system 2, according to an exemplary embodiment of the present disclosure. The process 300 commences with a copy of the digitized asset being sent to the matching service provider for accurate evaluation from sub-system 1 at step 302 and service required by asset owner at step 304 being assessed for match from service provider, not limiting to gold loan, credit card and the like. It is enquired at step 306 whether the assets are matched? If the enquiry to step 306 is yes, then a service request is created for matching service providers at step 308, following which proposals are submitted by the service provider at step 310. The submitted proposals are collated at step 310 which are then displayed to the asset owner at step 312. Following which at step 314, the asset owner selects appropriate service proposals which are notified to the service provider at step 316. Finally, at step 318 a copy of the digital asset is sent to the matching service provider for accurate evaluation.

The sub-system 1 captures the weight of the assets as part of the digitization process. The value of the asset is based on the amount of gold by weight in the asset. The amount of gold by weight in the system is calculated based on the purity of the asset. For example, a gold asset with weight of 10 g and 22 kt purity will have 9.1666 gms of gold.

Value=Wt in grams×Putiy ratio×bullion price per gram.

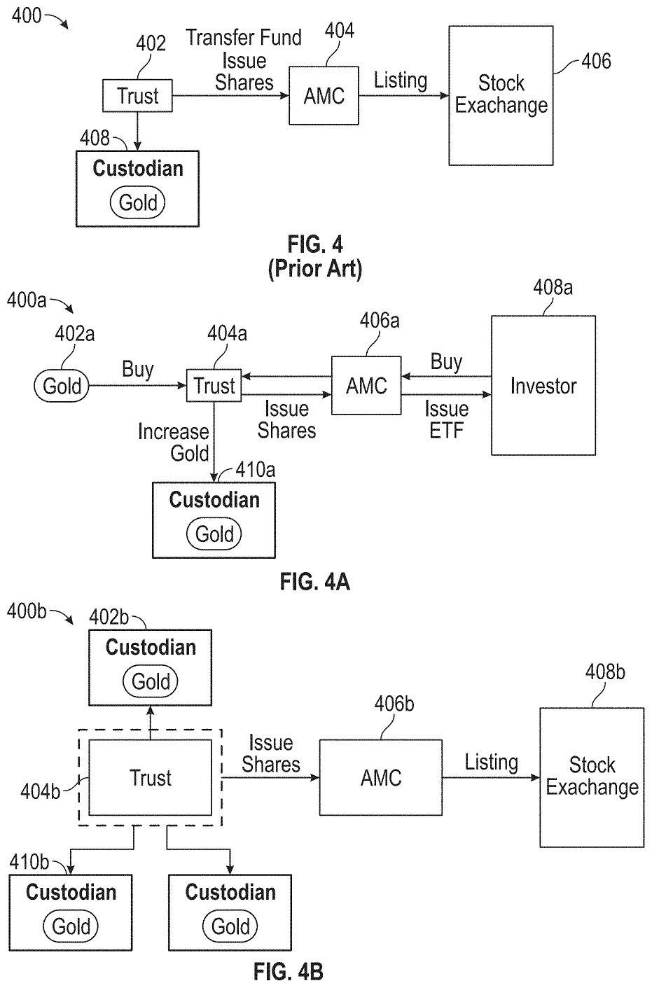

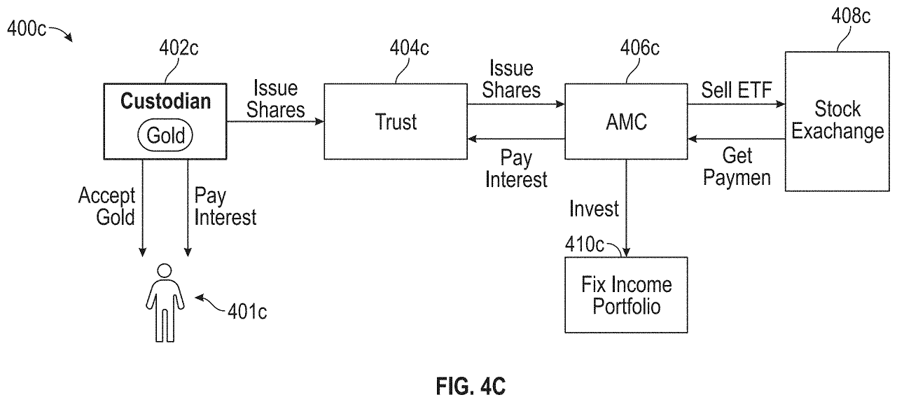

Referring to FIG. 4 is a prior art 400, depicting a Structure and Working a Gold exchange-traded fund (ETF), according to an exemplary embodiment of the present disclosure. An exchange-traded fund (ETF) is an investment fund that is listed and traded on a stock exchange. The fund invests in securities, bonds, commodities or derivatives like a mutual fund and the units of the fund are made available on stock exchanges for trading. A gold ETF invest in physical gold and the NAV of the ETF stock tracks the price of gold. Gold ETFs are used as an alternative to investing in physical gold, as it provides the better liquidity, lack of physical storage requirements and less fees compared to an actively managed mutual funds.

GOLD ETFs are generally structured as grantor trusts 402 one's own certain quantity of gold bars. The gold bars are held by custodians (owners or care takers of precious metal and/or gold) 408, which are usually banks or registered custodian entities, that store gold in their vault. The trust 402 then transfers the fund issues of the share of the trust, which represent fractional undivided beneficial interest in and ownership of the assets of the trust to sponsor or Asset Management Company (AMC) 404. The sponsor or the AMC is responsible for the administration of the ETF with involve creation and redemption of units, calculation of NAV, asset price tracking etc. The management fee of the ETF is met by selling the underlying gold asset at the stock exchange 406 for trading.

Referring to FIG. 4A is a block diagram 400a, depicting Structure Gold exchange-traded fund (ETF) unit creation process, according to an exemplary embodiment of the present disclosure. When institutional investors (depicted as investors in the diagram and numbered as 408a) raise a buy order for a bulk quantities of Gold 402a ETF units with the AMC 406a, the Trust 404a will purchase physical gold from the market and store it in the with the custodian 410a. The Trust 404a is authorized to issue new units to AMC 406a to be transferred to the institutional investors 408a. The unit creation happens when a new gold ETF is introduced to the market or when a bulk order for new unit is received by the AMC 406a.
a. Though convenient, this system has some drawbacks, not limiting to;
b. Custody Risk: There is a risk that part or all of the custodied gold could be lost, damaged or stolen. Access to it could also be restricted by natural events or human actions. Any of these actions may have adverse impact on the operations of the scheme.
c. Low income from gold: The underlying Gold held by the ETF does not have a yield or any dividends. This means the AMC will have to relay on capital gains or liquidation of gold to meet management expenses.
d. Erosion of NAV: NAV of the ETF will reduce over every year as the management fee is realized by selling a part of the gold held by the ETF. This may not be significant in the up market where the reduction can be offset by the capital gains of the ETF. In a down market, when the price of gold is falling and demand is low, it can result in significant gap with gold price in the market.

Referring to FIG. 4B is a block diagram 400b, depicting exchange-traded fund (ETF) working model, according to an exemplary embodiment of the present disclosure. By using proposed invention ETFs will be able to tap into the large quantity of idle gold asset hold by households. The ETF trust could use banks and/or other authorized entities that are on the platform to acquire gold from individuals (marked as individual custodian 402b in the diagram), digitize the gold asset and then issue ETF units based on immutable digital asset created on the platform. Instead of using a centralized custodian, the trust 404b is configured to use a distributed network of custodians 410b, that can directly acquire gold from individuals (marked as individual custodian 402b in the diagram). The newly created units will be sold on the stock market through a stock exchange 408b and the proceeding from the sale will be invested in fixed income securities. The yield from fix income securities will be used to pay the expenses, management fee of the fund and to pay an interest to the individual providing the gold investment. The digitized gold asset contains the full form factor information of the asset, its weight and purity. This would enable the ETF to smelt the gold jewellery at the time of acceptance and to 3D print the jewellery during withdrawal. This is a very easy method for reconstruction of smelted jewellery if needed by the custodian and/or to detect any theft or fiddling with the design of the jewellery piece.

Referring to FIG. 4C is a block diagram 400c, depicting a Modified Unit Creation Process, according to an exemplary embodiment of the present disclosure. ETF constituted in the new structure would accept gold from the individuals to create new units of ETF. The new units will be sold on the stock market and the proceedings of the sale. The unit creation process is as given below. The custodian of gold 402c gives interest to the individual 401c. The custodian 402c is equipped to issue shares to the trust 404c which further issues to the AMC 406c which on a reverse process is configured to pay the interest to the trust 404c. The AMC 406c sells the ETF to the stock market through a stock exchange 408c. The AMC 406c is further equipped to invest in any fixed income portfolio 410c like bonds, credit cards, issuance of secured gold loans, insurance sector and the like, without limiting the scope of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

We claim:

1. A system for digitization financialization and digital valuation of precious metal assets comprising of:
a first subsystem 104 and a second subsystem 106, also referred to as subsystem 1 104 and subsystem 2 106 respectively, whereby the first subsystem 104 comprises of an asset data digitizer 104a to create an immutable digital record 104b of the precious metal asset of the user 102 preferably as a 3D scan, whereby, the output of the first subsystem 104 is an input of the second subsystem 106, whereby the second subsystem 106 is configured to make the asset records available to plurality of financial service providers from at least one of: bank; non-banking financial companies; credit card companies; insurance service providers; securitisation companies and the like, based on the requirements of the user 102 through a user interface 106a, whereby the financial services are from at least one of: all banking activities; all non-banking activities; bitcoins; credit-card; precious-metals loans and the like, whereby the user interface 106a belongs to the user and financial service provider interface belongs to the financial service providers, whereby the user interface 106a is configured to enable the user 102 to choose the services 106c that suit the user's 102 requirements by comparing the competitive offers and close the deal, whereby the system 100 uses the standard know your customer (KYC) process to identify the user 102 who is the owner of the precious metal asset.

2. The subsystem 1 as claimed in claim 1, wherein the immutable record 1 104b created by the first subsystem 104 captures the various properties of the asset from at least one of: the kind of asset; its dimension; its weight; its purity and ownership.

3. The subsystem 1 as claimed in claim 1, wherein its output acts as an irrefutable record of ownership and value of the assets.

4. The user interface as claimed in claim 1 wherein, the financial service provider interface involves a Web based dashboard configure to be provided to financial service providers to view the overall transaction details and new service requests.

5. A method of asset digitization process occurring in first subsystem 104 and a second subsystem 106 respectively comprising of:
placing of asset by the user 102 in a tray provided in first subsystem 104, whereby the transaction button for placement of the asset and valuation of the asset is done upon user authentication and the valuation of the asset is performed by considering at least one of: High fidelity video; Weight and Purity of the asset and relevant calculations are performed, whereby the obtained records and data is replicated in the record with sub-system 2's distributed ledger; and
a service delivery process occurring in second subsystem 106, whereby the service requests generated in first subsystem 104 are matched to synchronize the user's 102 requirement and the financial service provider's service, whereby a plurality of proposals are submitted to the service provider based on the user's 102 requirement, whereby the submitted proposals are collated and displayed to user 102 and the chosen service is then forwarded to the relevant financial service provider where a copy of the digital asset is sent to the matching service provider for accurate evaluation.

6. The method as claimed in claim 5, wherein the revenue will be a basis point of the value of transactions happening on the system.

7. A system for exchange traded fund considering gold bar as the financial asset comprising of:
a plurality of individual custodians 402b of the financial assets, preferably gold, whereby a trust 404b is configured to use a distributed network of custodians 410b, whereby the newly created units will be sold on the stock market through a stock exchange 408b, whereby the proceeding from the sale is invested in fixed income securities, whereby the individual custodians 402b are equipped to issue shares to the trust 404c which further issues to pluralities of asset management companies 406c relevant to the individual custodians 402b.

8. The method as claimed in claim 7, wherein the trust 404b is configured to directly acquire gold from individual custodians 402b.

9. The method as claimed in claim 7, wherein the yield from fix income securities is used to pay the expenses not limiting to: management fee of the fund; and to pay an interest to the individual providing the gold investment.

10. The method as claimed in claim 7, wherein the asset management company 406c is further equipped to invest in any fixed income portfolio 410c.
